(19) United States
(12) Patent Application Publication
(10) Pub. No.: US 2015/0046927 A1
(43) Pub. Date: Feb. 12, 2015

(54) Allocating Processor Resources

(71) Applicant: Microsoft Corporation, Redmond, WA (US)

(72) Inventors: Christoffer Asgaard Rödbro, Stockholm (SE); Jon Anders Bergenheim, Uppsala (SE); Thomas Stuart Yates, Stockholm (SE)

(73) Assignee: Microsoft Corporation, Redmond, WA (US)

(21) Appl. No.: 14/103,757

(22) Filed: Dec. 11, 2013

(30) Foreign Application Priority Data
Aug. 6, 2013 (GB) 1314067.8

(51) Int. Cl. G06F 9/50

(52) U.S. Cl. CPC G06F 9/50
USPC 718/104

(57) ABSTRACT

Disclosed herein is a method of allocating resources of a processor executing a first real-time code component for processing a first sequence of data portions and a second code component for processing a second sequence of data portions. At least the second code component has a configurable complexity. The method comprises estimating a first real-time performance metric for the first code component, and configuring the complexity of the second code component based on the estimated first real-time performance metric.

### RELATED APPLICATION

This application claims priority under 35 USC 119 or 365 to Great Britain Application No. 1314067.8 filed Aug. 6, 2013, the disclosure of which is incorporate in its entirety.

### BACKGROUND

Modern audio and video processing components (such as encoders, decoders, echo canceller, noise reducers, anti-aliasing filters etc.) can typically achieve higher output audio/video quality by employing more complex audio/video algorithmic processing operations. These operations are typically implemented by one or more software applications executed by a processor (e.g. CPU) of a computing system. The application(s) may comprise multiple code components (for instance, separate audio and video processing components), each implementing separate processing algorithms Processor resource management in the present context pertains to adapting the complexity of such algorithms to the processing capabilities of such a processor. As used herein “complexity” of a code component implementing an algorithm refers to a temporal algorithmic complexity of the underlying algorithm. As is known in the art, the temporal complexity of an algorithm is an intrinsic property of that algorithm which determines a number of elementary operations required for that algorithm to process any given input, with more complex algorithms requiring more elementary processing operations per input than their less sophisticated counterparts. As such, this improved quality comes at a cost as the more complex, higher-quality algorithms either require more time to process each input, or they require more processor resources, and thus result in higher CPU loads, if they are to process input data at a rate which is comparable to less-complex, lower-quality processing algorithms.

For “real-time” data processing, such as processing of audio/video data in the context of audio/video conferencing implemented by real-time audio/video code components of a communication client application, quality of output is not the only consideration: it is also strictly necessary that these algorithmic operations finish in “real-time”. As used herein, in general terms, “real-time” data processing means processing of a stream of input data at a rate which is at least as fast as an input rate at which the input data is received (i.e. such that if N bits are received in a millisecond, processing of these N bits must take no longer than one millisecond); “real-time operation” refers to processing operations meeting this criteria. As such, allowing the more complex algorithms more processing time is not an option as the algorithm has only a limited window in which to process N bits of the stream, that window running from the time at which the N bits are received and the time at which the next N bits in the stream are received—the algorithmic operations needed to process the N bits all have to be performed within this window and cannot be deferred if real-time operation is to be maintained. Therefore more processor resources are required by a code component as its complexity increases if it is to maintain real-time operation. Further, if CPU load is increased beyond a certain point—for instance, by running unduly complex audio/video processing algorithms—then real-time operation will simply not be possible as the audio and/or video components would, in order to operate in real-time, require more processor resources than are actually available. Thus, there is a trade-off between maximising output quality on the one hand whilst preserving real-time operation on the other.

In the context of audio/video processing specifically, raw audio and video data is processed in portions, which are then packetized for transmission. Each audio data portion may be (e.g.) an audio frame of 20 ms of audio; each video data portion may be (e.g.) a video frame comprising an individual captured image in a sequence of captured images. In order to maintain real-time operation, processing of an audio frame should finalize before capture of the next audio frame is completed; otherwise, subsequent audio frames will be buffered and an increasing delay is introduced in the computing system. Likewise, processing of a video frame should finalize before the next video frame is captured for the same reason. For unduly complex audio/video algorithms, the processor may have insufficient resources to achieve this.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect, the present disclosure is directed to a method of allocating resources of a processor executing a first real-time code component for processing a first sequence of data portions and a second code component for processing a second sequence of data portions. At least the second code component has a configurable complexity. The method comprises estimating a first real-time performance metric for the first code component, and configuring the complexity of the second code component based on the estimated first real-time performance metric.

By so configuring said complexity, processing resources of the processor are effectively allocated to the second code component in a manner which is sensitive to real-time performance requirements of the first component. In embodiments, the second real-time component may also be a real-time component but this is not essential.

The first and second data sequences may be different types of data. For example, the first sequence may be a sequence of frames of audio data and the second sequence may be a sequence of frames of video data, the first code component being an audio code component implementing an audio encoding algorithm and the second being a video component implementing a video encoding algorithm (or vice versa).

### BRIEF DESCRIPTION OF DRAWINGS

For a better understanding of the described embodiments and to show how the same may be put into effect, reference will now be made, by way of example, to the following drawings in which:

FIG. 1 shows a schematic illustration of a communication system;

FIG. 2 is a schematic block diagram of a user device;

FIG. 3A is a schematic block diagram of audio and video processing;

FIG. 3B is a schematic block diagram of audio and video processing at a time subsequent to FIG. 3A;

FIG. 4 is a schematic block diagram illustrating processor resource management.

### DETAILED DESCRIPTION

To aid understanding, it is useful to consider the following example: suppose an unprocessed audio frame comprises N samples, each of M-bits. A first extremely basic down-sampling algorithm might act to simply halve the number of samples by ‘skipping’ every second sample. A second, somewhat more sophisticated down-sampling algorithm on the other hand, may perform a low-pass filtering of the audio frame (using e.g. an approximate sinc filter) to suitably reduce signal bandwidth before ‘skipping’ every second filtered sample. The second algorithm is more complex than the first as, broadly speaking the same number of elementary operations are required to perform the ‘skipping’ steps for each, but additional elementary operations are required to perform the additional filtering steps of the second. Thus the second would require more processor resources than the first to maintain real-time operation when processing a stream of audio data but would, in accordance with the Nyquist sampling theorem, generally be expected to result in a higher output quality than the first as is known in the art. Nonetheless, if this increased quality comes at the expense of compromised real-time operation due to there being insufficient resources available to handle the additional operations of the second algorithm in real-time, it would, in a real-time context, be desirable to degrade quality by using the first algorithm rather than suffer accumulating delays with the second. Of course, as will be appreciated, this is an extremely simplified example for the purposed of illustration only (and that, in reality, no modern CPUs are slow enough that LP filtering would ever be a realistic problem).

One way of controlling system load would be to run a benchmarking test prior to actual application invocation, and configure real-time code components (such as the real-time audio and video processing code components) of applications with respect to complexity in dependence thereon i.e. to set complexities at levels which maximize quality without compromising real-time operation prior to run-time. However, such an approach is incapable of adapting to changing conditions, such as CPU clock frequency reduction due to overheating or other applications starting or stopping thereby reducing or freeing up available system resources.

This could be circumvented by monitoring the system CPU load as reported by an operating system (OS), and regulating algorithmic complexity to keep the system load below some pre-specified target, for example 95%. However, keeping system load below some pre-specified target is difficult because it is impossible to select a pre-specified target that guarantees real-time operation across different systems that will not result in unnecessarily compromised quality on at least some systems. This is because, on certain systems, real-time operation may be compromised at CPU loads as low as (say) 60% whereas other systems can be loaded to (say) 99% without any problems. Thus, the target needs to be pre-set at as (say) 60% to guarantee real-time operation across a majority of systems, which means those systems which can be loaded above 60%, and therefore achieve higher qualities, without compromising real-time operation are underutilized such that quality is unnecessarily degraded. Moreover, there is an additional difficulty in that certain computing devices may not even be able to report on the system load in the first place.

Another option would be to regulate computational complexity ‘on-the-fly’ based on a technique whereby (e.g.) audio coding complexity is regulated based on monitoring a time taken to encode each audio frame relative to a target, this being indicative of processor resource usage.

That is, resources could be managed by monitoring a code component to determine whether it is utilizing processor resources to an extent that it is compromising its own real-time operation (i.e. determining that real-time operation would require more resources that there are available) or to determine whether it is under-utilizing processor resources (i.e. determining that the component could occupy more resources, and therefore achieve higher quality of output, without compromising its own real-time operation), and reconfiguring the complexity of that code component according to the determined processor resource usage.

However, the inventors have recognized that such a technique would be deficient for the following reasons. Because contemporaneously executed real-time code components implementing different functions (such as audio coding, video coding etc.) share the same processor resources, when a first component (e.g. audio) experiences real-time problems, instead of reducing its own complexity, it may in fact be more appropriate to reduce the complexity of another second component (e.g. video), thereby reducing the amount of resources required by the second component and thus freeing-up resources for use by the first component. For example, in a video-call scenario (in which both audio and video must be captured and processed in real-time for transmission over a network), it may be important to maintain high-quality audio, even at the cost of reducing video quality (on the basis that it is more important for call participants to hear one another clearly than it is for them to see one another clearly). That is, it may be acceptable to degrade video quality to some extent in favour of maintaining audio quality.

Moreover, were multiple components to implement this technique contemporaneously then you would have multiple components ‘fighting’ each other (i.e. multiple components all ‘blindly’ trying to push their individual loads up to, say, 0.95). This would either lead to the most aggressive component tending to win all system resources or, if all components are equally aggressive, it may lead to oscillation as follows: free system resources would be ‘seen’ by all components; therefore, they would all increase complexity at the same time. As a result, the net effect of all these increases may lead to overload, causing them all to ‘back down’ again. At this point, there wold be free resources again, causing them all to increase complexity to overload (and so on).

Specific, non-limiting embodiments are described in detail below, but some of the underlying principles employed therein can be outlined as follows:

1. Monitor real-time performance of a first set of code components containing at least one (first) real-time code component;
2. In dependence of an output of this monitoring, determine if algorithmic complexity of algorithms implemented by a second set of code components containing at least one other (second) code component (which may or may not be real-time) can be increased, should be decreased, or kept at current level;
3. Configure the second set of code components in dependence on said determination.

The set of components monitored in step 1 (first set) and the set configured in step 3 (second set) may be identical (such that each code component is both monitored and configured), partially overlapping (such that only some code components are both monitored and configured), or disjoint (such that no code component is both monitored and configured). In other words, the first and second sets may be the same, they may be different but have at least one common code component, or they may be different and share no code components. Observations made on at least one real-time code component are used to configure at least another (different) code component (which has a configurable complexity and which may or may not be a real-time component). Either or both of the first or second sets may contain multiple code components. The first and second components may be components of a (same) software application, or components of different software applications.

Each configurable code component is independently configurable (i.e. each component in the second set is configurable independently from each code component in the first set). That is, a second code component having a configurable complexity is configurable independently from a first code component for which a real-time performance metric is estimated (such that an algorithm implemented by the second code component can be modified without modifying an algorithm implemented by the first code component).

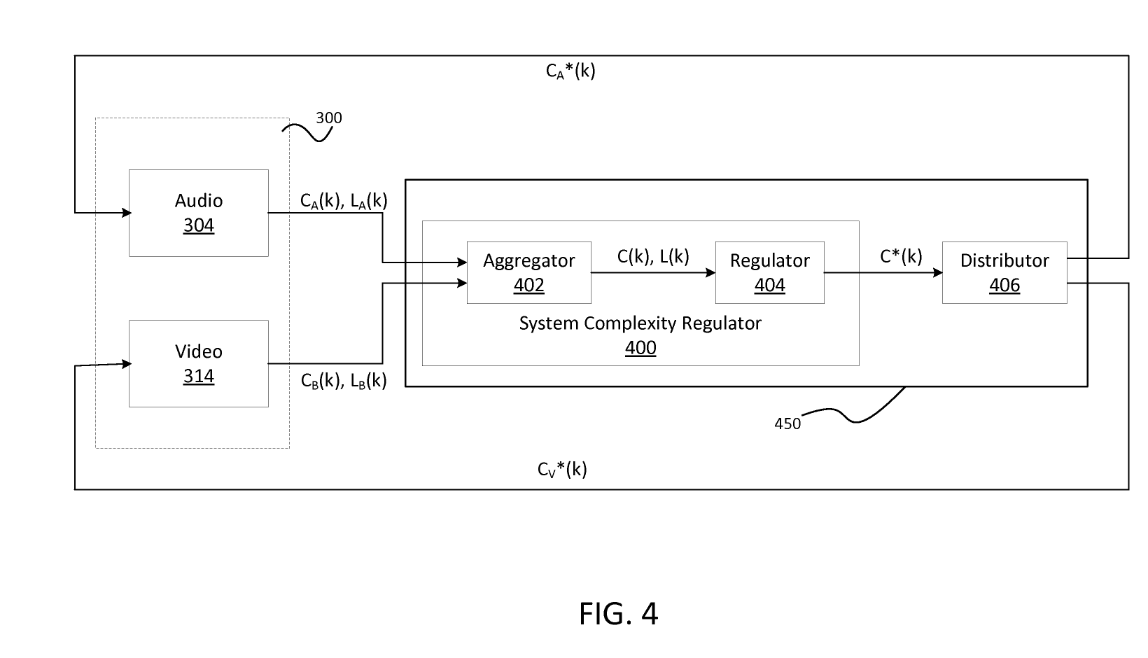

The techniques disclosed herein represent a form of high-level resource management (in the embodiments described below, resource management is performed by resource manager 450 of FIG. 4). Step 2 in the above amounts to a determination of processing resources available to the second set of components given the performance of the first set i.e. a determination that components of the second set could in fact use more resources (and therefore attain higher output quality) than they are currently using without compromising real-time operation of any of the first set, or a determination that components of the second set are over-utilizing resources to the extent that real-time operation of at least one component of the first set is being compromised, or a determination that the second set of components are using a ‘correct’ amount of resources such that real-time operation of the first set is uncompromised without any underutilization of processing resources by the second set (which indicates that output quality of the second set of components is about as high as can be achieved in real-time given the requirements of the first set). Step 3 amounts to a configuration of the second set to the determined available processing resources.

It should be noted that, viewed in terms of low-level processor operations, the present technique ultimately allocates processor resources by adjusting a number of low-level machine-code instructions needed to implement processing functions such as audio or video processing (as less complex algorithms are realized using fewer machine-code instructions). This is in contrast to, say, a low-level thread scheduler which merely allocates resources to different threads by selectively delaying execution of thread instructions relative one another and which has no effect on the nature of the algorithms themselves—in particular, no effect on their complexities—i.e. which has no impact on the nature, and in particular the number, of machine-code instructions which need to be executed in order to process an input but merely determines when said instructions are executed.

The above principles are provided only as a guide to further aid understanding of specific embodiments described below, and are not to be construed as limiting per se.

Embodiments will now be described in the context of a real-time communication application with reference to the accompanying drawings.

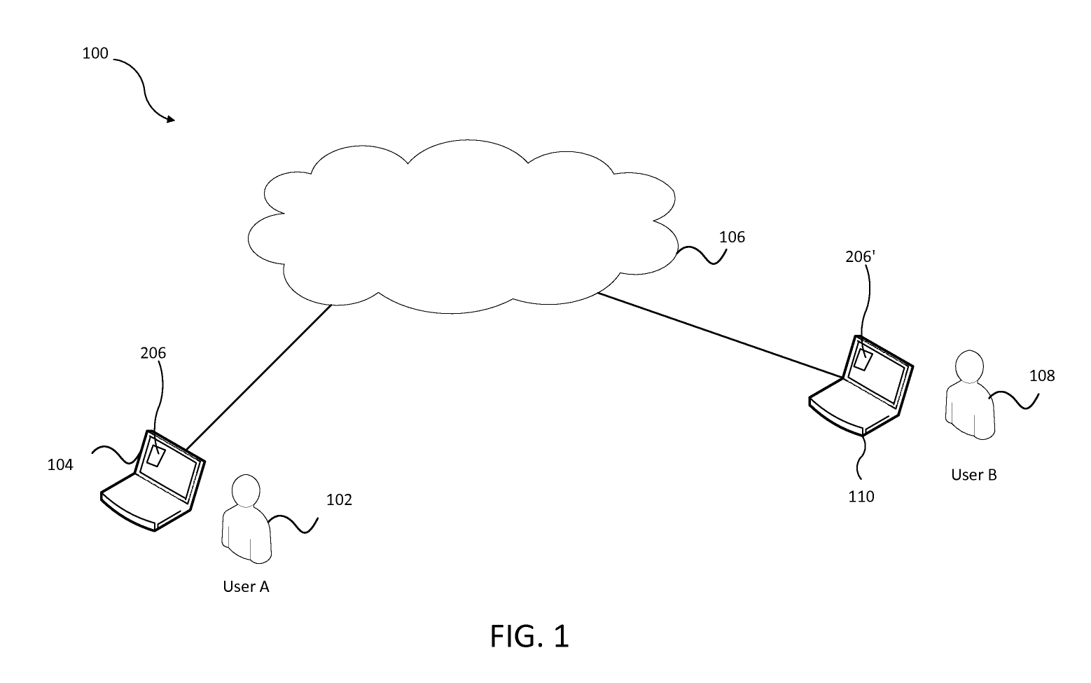

FIG. 1 shows a communication system 100 comprising a first user 102 (“User A”) who is associated with a first user device 104 and a second user 108 (“User B”) who is associated with a second user device 110. The user devices 104 and 110 can communicate over a network 106 in the communication system 100 in real-time, thereby allowing the users 102 and 108 to communicate with each other over the network 106 in real-time.

The communication system 100 shown in FIG. 1 is a packet-based communication system, but other types of communication system could be used. The network 106 may, for example, be the Internet. Each of the user devices 104 and 110 may be, for example, a mobile phone, a tablet, a laptop, a personal computer (“PC”) (including, for example, Windows®, Mac OS® and Linux® PCs), a gaming device, a television, a personal digital assistant (“PDA”) or other embedded device able to connect to the network 106. The user device 104 is arranged to receive information from and output information to the user 102 of the user device 104. The user device 104 comprises output means such as a display and speakers. The user device 104 also comprises input means such as a keypad, a touch-screen, a microphone for receiving audio signals and/or a camera for capturing images of a video signal. The user device 104 is connected to the network 106.

The user device 104 executes an instance of a communication client 106, provided by a software provider associated with the communication system 100. The communication client is a software program executed on a local processor in the user device 104. The client performs the processing required at the user device 104 in order for the user device 104 to transmit and receive data over the communication system 100.

The user device 110 also executes, on a local processor, a communication client 106′ which corresponds to the communication client executed at the user device 104. The client at the user device 110 performs the processing required to allow the user 108 to communicate over the network 106 in the same way that the client at the user device 104 performs the processing required to allow the user 102 to communicate over the network 106. The user devices 104 and 110 are endpoints in the communication system 100.

FIG. 1 shows only two users (102 and 108) and two user devices (104 and 110) for clarity, but many more users and user devices may be included in the communication system 100, and may communicate over the communication system 100 using respective communication clients executed on the respective user devices.

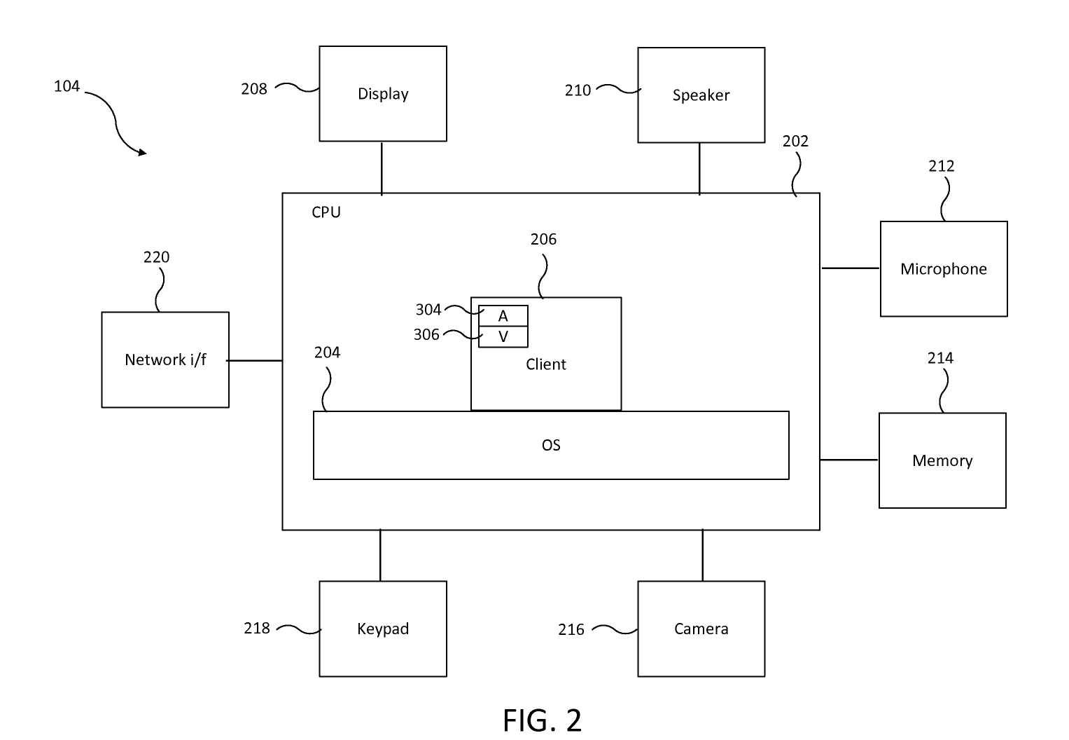

FIG. 2 illustrates a detailed view of the user device 104 on which is executed communication client instance 206 for communicating over the communication system 100. The user device 104 comprises a processor in the form of a central processing unit (“CPU”) 202. It will of course be appreciated that the processor could take alternative forms, such as a multi-core processor comprising multiple CPUs. The following components are connected to CPU 202: output devices including a display 208, (implemented e.g. as a touch-screen), and a speaker 210 for outputting audio signals; input devices including a microphone 212 for capturing audio signals, a camera 216 for capturing images, and a keypad 218; a memory 214 for storing data; and a network interface 220 such as a modem for communication with the network 106. The display 208, speaker 210, microphone 212, memory 214, camera 216, keypad 218 and network interface 220 are integrated into the user device 104, although it will be appreciated that, as an alternative, one or more of the display 208, speaker 210, microphone 212, memory 214, camera 216, keypad 218 and network interface 220 may not be integrated into the user device 104 and may be connected to the CPU 202 via respective interfaces.

Raw video data (“raw” in the sense that they are substantially un-processed and un-manipulated) in the form of a sequence of video frames (i.e. digital images captured by, e.g., a Charge-coupled device (CCD) image sensor of camera 216) are input to CPU 202. Audio signals captured by microphone 212 (e.g.) as a time-varying voltage are sampled and converted into raw digital audio data (which is, again, substantially un-processed and un-manipulated), which are input to CPU 202.

FIG. 2 also illustrates an operating system (“OS”) 204 executed on the CPU 202. Running on top of the OS 204 is the software of the client instance 206 of the communication system 100. The operating system 204 manages hardware resources of the computer and handles data being transmitted to and from the network 106 via the network interface 220. The client 206 communicates with the operating system 204 and manages the connections over the communication system. The client 206 has a client user interface which is used to present information to the user 102 and to receive information from the user 104. In this way, the client 206 performs the processing required to allow the user 102 to communicate over the communication system 100.

In particular, the client 206 performs the processing required to allow the user 102 to conduct voice-and-video calls (referred to hereinafter as “video calls” for simplicity) over network 106. That is, client 206 of user device 104 is operable to transmit and receive packetized audio data and synchronized packetized video data via network 106. The transmitted audio and video data is ultimately derived from corresponding raw data captured by microphone 212 and camera 216 respectively, and processed as discussed below.

This transmission occurs in “real-time” in the sense that each data packet is transmitted to user device 110 after a substantially fixed delay relative to capture of the corresponding raw audio/video data. That is, such that there is no accumulation of delays between capture and transmission (which would lead to an increasing disparity between the time at which, say, user 102 speaks and the time at which user 110 hears and sees her speaking)

In order to produce such packetized data, client 106 processes the raw audio and video data (to reduce their respective sizes, among other things). Specifically, client 206 comprises an audio code component 304 implementing one or more audio processing algorithms for encoding raw audio data. Similarly, client 206 comprises a video code component 306 implementing one or more video processing algorithms for encoding raw video data. Components 406 and 306 are executed on CPU 202 as part of client 206 and form part of a media processing system 300 of client 206.

Audio and video data is processed in frames (i.e. a frame at a time). Each audio and video data frame comprises at least one captured sample (audio from microphone 212 and images from camera 216 respectively). For instance, audio captured by microphone 212 may be sampled at a standard rate of (say) 44.1 kHz and a bit depth of (say) 16 bits, with each audio frame comprising 20 ms of raw sampled audio data. Each frame of raw video data comprises one captured image from camera 216 (i.e. one “sample”).

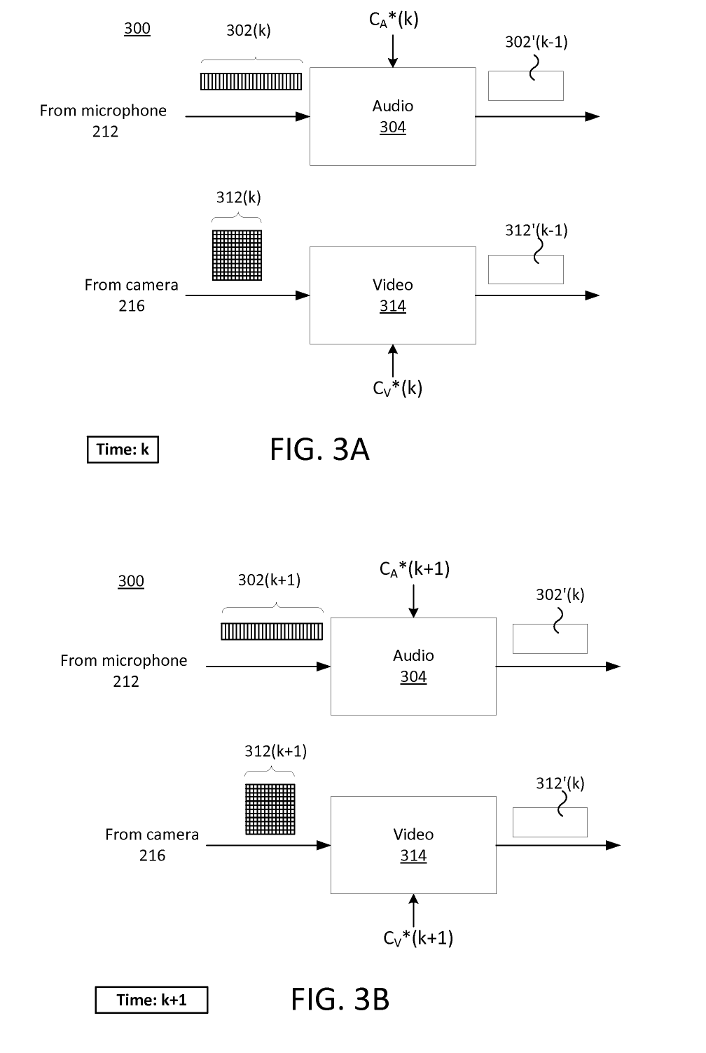

As illustrated in FIGS. 3A and 3B, audio component 304 encodes, in sequence, audio frames 302(k), 302(k+1) etc. Here, k represents a time as measured with reference to a suitable clock or an iteration index which is increased, for all components, every time a code component processes a data portion such as an audio frame or video frame, and which thus is representative of a time which is “universal” across code components.

A sequence of audio frames 302(k), 302(k+1) etc. are received by audio component 304 as inputs. As shown in FIG. 3A, an audio frame 302(k) is received as an input by audio component 304 at time k. The audio frame 302(k) is encoded by audio component 304 to produce an encoded audio frame 302′(k) in a time T_{A} (k). As shown in FIG. 3B, a subsequent audio frame 302(k+1) in the sequence of audio frames is received at time k+1 corresponding one frame length (20 ms) after capture of audio frame 302(k) has been completed.

As further illustrated in FIGS. 3A and 3B, video component 314 encodes raw video data contemporaneously with audio component 304. Video component 314 processes video frames 312(k), 312(k+1) etc. which are received sequentially.

Purely for the sake of simplicity, FIGS. 3A and 3B illustrate a situation in which video frames are captured every 20 ms (i.e. in intervals of time “1” in units of k) such that sequential video frames are separated by 20 ms, capture of each video frame being substantially synchronous with capture of each audio frame. This synchronized capture is not at all essential, or even likely in practice (audio and video could be synchronized though use of e.g. time stamps but is usually necessary: as both are real-time, there is no time to introduce significant misalignment of audio and video), and video frames may alternatively be captured, for instance, at a standard rate of (say) 24 frames per second (i.e. one frame about every 42 ms), or 36 frames per second (i.e. one frame about every 28 ms).

As shown in FIG. 3A, a video frame 312(k) is received as an input by video component 314 at time k. The video frame 312(k) is encoded by video component 304 to produce an encoded video frame 312′(k) in a time T_{V}(k). As shown in FIG. 3B, a subsequent video frame 312(k+1) in the sequence of video frames is captured and received at time k+1.

Audio component 304 has a configurable complexity. That is, one or more of the audio processing algorithm(s) implemented by the audio component can be modified so as to modify the (algorithmic) complexity of the audio component 304. In general, reducing (resp. increasing) the complexity of the audio component shortens (resp. lengthens) the encoding time T_{A}(k). If the time T_{A}(k) were to exceed the frame length, then audio component 304 would not have completed the encoding of audio frame 302(k) by the time capture of audio frame 302(k+1) is completed, resulting in accumulating delays thereby preventing real-time transmission (discussed above). On the other hand, the encoded audio frame 302′(k) has a quality which generally worsens (resp. improves) as the complexity of the audio component is reduced (resp. increased). Therefore, it is necessary to find a balance such that audio encoding occurs sufficiently quickly to allow real-time transmission but without excessive reduction in audio quality.

Audio complexity is reconfigured at audio frame boundaries (i.e. such that complexity is fixed at least for the duration of each frame). It could, in theory, be re-configured on a per-audio frame basis; however in practice it is not necessary, or even desirable, to configure per-frame. For instance, re-configuration may be implemented by a codec change, and doing that too frequently is undesirable and could, for example, cause undesired artefacts (for audio, such changes are liable to be restricted such that a change cannot occur more than, say, once per 10 seconds).

Similarly, video component 314 has a configurable complexity. That is, one or more of the video processing algorithm(s) implemented by the video component can be modified so as to modify the (algorithmic) complexity of the video component 314. In general, reducing (resp. increasing) the complexity of the video component shortens (resp. lengthens) the encoding time T_{V}(k). However, if the time L_{V}(k) were to exceed the video frame separation, then video component 314 would not have completed the encoding of video frame 312(k) by the time video frame 302(k+1) is captured, again resulting in accumulating delays. On the other hand, the encoded video frame 312′(k) has a quality which generally worsens (resp. improves) as the complexity of the video component is reduced (resp. increased). Therefore, it is again necessary to find a balance such that video encoding occurs sufficiently quickly but without excessive reduction in video quality.

Video complexity is reconfigured between video frame boundaries (i.e. complexity is fixed for a given frame). Again, whilst possible in theory, reconfiguring on a per-video frame basis is generally undesirable for the same reasons as discussed above (although video is somewhat more accommodating to more frequent changes than audio).

However, as discussed, the inventors have recognized that there are additional considerations, explained in more detail below.

Because the contemporaneously executed audio and video components share the same processor resources, the encoding time T_{A}(k) for encoding an audio frame 302(k) depends not only on the complexity of the audio component 304, as this determines an amount of resources which are required by the audio component 304, but also on the complexity of the video component 314, as this determines an amount of resources which are required by the video component 314 and which are therefore not available for use by the audio component 304. Similarly, the encoding time T_{V}(k) for encoding a video frame 312(k) depends not only on the complexity of the video component 314, as this determines an amount of resources which are required by the video component 314, but also on the complexity of the audio component 304, as this determines an amount of resources which are required by the audio component 304 and which are therefore not available for use by the video component 314.

Phrased in more general terms, performance of a code component X depends not only on the complexity of X (which determines an amount of processor resources required by X), but also on the complexity of any other code components executed substantially contemporaneously with X (as this determines an amount of processor resources required by the other components and which are therefore not available for use by component X).

For this reason, a real-time performance metric of at least one component (e.g. audio component 304, resp. video component 314) is determined, and the complexity of at least one other (different) component (e.g. video component 314, resp. audio component 304) is configured, by resource manager 450 of FIG. 4, in dependence thereon. In general, a real-time performance metric of a code component, having a particular configuration (i.e. configured to have a particular complexity) and therefore performing in a certain manner, is a function which quantifies said performance in a way that is indicative at least of whether or not said performance is liable to compromise real-time operation of the code component, and which may also be indicative of “over-cautious” processing (that is, processing which exceeds a processing speed required to preserve real-time operation such that quality of processing is unnecessarily compromised). At any given time, the real-time performance metric of a code component having a particular configuration may be estimated by monitoring real-time performance of the code component and by making dynamic observations of said performance though direct or indirect measurement (e.g. of processing time, buffer occupancy etc.).

In the examples below, the real-time performance metric is defined, for component X having a particular configuration, relative to a target processing time T (which is optionally set equal to the frame length). Specifically, the real-time performance metric is defined as a load L_{X}(k) which is (e.g.) a ratio of T_{X}(k) to T (i.e. T_{X}(k)/T), T_{X}(k) being an actual (measured) time taken by component X to process a data portion. However, alternative real-time performance metrics are envisaged.

The complexity of the audio component 304 is then configured in dependence on a complexity target metric C_{A}*(k) which is received by audio component 304 as an input and which has at least some dependence on an estimated value of L_{V}(k). The complexity of the video component 314 is configured in dependence on a complexity target metric C_{V}*(k) which is received by video component 314 as an input and which has at least some dependence on an estimated value of L_{A}(k).

This will now be described in more detail with reference to FIG. 4. As shown in FIG. 4, audio component 304 and video component 314 are coupled to and provide respective outputs to an aggregator 404. Aggregator 402 is coupled to and provides an output to a regulator 404. Aggregator 402 and regulator 404 form part of a system complexity regulator 400. Regulator 404 is coupled to and provides an output to a distributor 406 which, in turn, is coupled to and provides respective outputs to both audio component 304 and video component 314, thereby creating a closed feedback loop. Like the audio and video components, aggregator 402, regulator 404, complexity regulator 400 and distributor 406 are implemented as code executed on CPU 202, this code forming part of client 206 (although alternative implementations, both software and hardware, are envisaged and will be apparent). Complexity regulator 400 and distributor 406 form part of resource manager 450.

In this embodiment, the audio and video components each report a respective load indicator L_{X}(k) (with Xε{A,V}) to aggregator 402. Alternatively, only one reports a load indicator. Each component X also reports a complexity metric C_{X}(k) relating to the complexity of the current configuration of component X. There is a degree of flexibility in setting C_{X}(k) values as explained in more detail below; in fact, as also explained below, it is alternatively possible to operate entirely without any C_{X}(k).

Complexity regulator 400 is configured to process the input load indicators and complexity metrics to produce an overall real-time performance metric in the form of an overall system load indicator L(k) and an aggregate complexity metric C(k), which are both input to regulator 404. In dependence thereon, regulator 404 determines a new total complexity target metric C*(k) to apply to the media processing system 300. This C*(k) value is then fed to a distributor that decides how to split the new total complexity over the audio and video components and specifies suitable individual complexity target metrics C_{X}*(k) to each component accordingly.

The complexities C_{X}*(k) are in the same metric (i.e. the same “units”) as C_{X}(k). They are fed back to each component X and one or more components is reconfigured to comply with the specified target complexities C_{X}*(k) if necessary. That is, if C_{X}(k) deviates from C_{X}*(k) by more than a predetermined tolerance level, before processing a next data portion (e.g. 302(k+1), 312(k+1)), component X is reconfigured to have a complexity C_{X}(k+1) (as reported to aggregator 402), with C_{X}(k+1) either equal to C_{X}*(k) or as high as possible without exceeding C_{X}*(k) if a complexity of C_{X}*(k) cannot be achieved exactly by component X. It would, for instance, be possible to specify that component X is allowed to use any C_{X}(k+1)≦C_{X}*(k) should it wish to for some reason (for example, codec switching can lead to artefacts so a ‘small’ increment in complexity may not be worthwhile; alternatively, a component may utilize less CPU than allocated, for example, if it chooses to apply a memory saving algorithm that also happens to use less CPU than allocated).

This may be achieved, for instance by reconfiguring one of more processing algorithms implemented by component X. This can be achieved in many ways.

For example, in the cause of an audio encoder, complexity could be reconfigured by switching to another codec (either from memory or loaded from storage). E.g. G711 standard coding has a very low complexity, whilst AMR-WB (Adaptive Multi-Rate Wideband) coding has a high complexity; complexity could be reconfigured by switching between the two (and possibly other) codecs. Alternatively, some codecs (e.g. SILK compression) contain specific complexity levels (i.e. have adjustable complexity settings, which can be set to, say, “low”, “medium” and “high”), as known in the art. Further, some codecs (e.g. SILK) can operate at different sample rate: data is captured at (say) 44.1 kHz then downsampled to, say, on of 8, 12, 16, or 24 kHz, before applying the advanced audio compression techniques (more aggressive downsampling resulting in lower complexity).

In the case of a video encoder, a video processing algorithm could be adapted to (e.g.) skip processing of some frames (reduce frame rate), and/or to downscale images before processing (reduced resolution). Also, some modern codecs have specific complexity modes which enable complexity to be reconfigured by (e.g.) placing restrictions on motion vector search.

Other ways in which configurable complexity of code components can be realized will be apparent to those skilled in the art.

For the calculation of L_{X}(k), each component X monitors the respective time it takes to encode a media frame (i.e. audio or video frame) relative to a target processing time, set as the relevant data portion length in this embodiment. For example, if it takes 15 ms to encode a 20 ms frame, L_{X}(k)=15/20=0.75. Each component may supply this ratio to the controller for each and every frame, or it may supply an average over a time averaging interval. Another option is to calculate L_{X}(k) in dependence of any build-up in a buffer (e.g. an encoding buffer used by the audio or video component). For example, component X may specify a target of delaying encoding by maximally 20 ms, so if a buffer delay is actually 30 ms, L_{X}(k)=30/20=1.5. Again, this value may be time-averaged before being fed to the complexity regulator 400.

Optionally, as well as code components calculating these load indicators, it is also possible to add a load indication L_{SYS}(k) based on reporting from the operating system 204, with L_{SYS}(k) normalized such that L_{SYS}(k)=0 represents a CPU load of 0% and L_{SYS}(k)=1 represents a CPU load of 100%. This could lead to increased robustness in certain systems.

The complexity regulator starts with an aggregation step performed by aggregator 402. First and foremost, this is to simplify the regulation step by combining multiple C_{X}(k) and L_{X}(k) reports from different components into metrics for aggregate system complexity and overall system load. In this embodiment, the aggregated complexity is computed as the sum of the complexities C_{X}(k) of the individual components:

C(k)=sum_{X}C_{X}(k).

The overall system load is computed as the maximum of the loads L_{X}(k) reported by individual components:

$$L ( k ) = {max}_{X} {L}_{X} ( k ) .$$

The maximum (as opposed to, say, an average of reported load indicators) is taken as components may use differently prioritized threads meaning that a high priority component may see and report minimal load even during a system overload. If L_{SYS}(k) is reported, the overall system load L(k) is then the maximum of each L_{X}(k) and L_{SYS}(k) i.e. L(k)=max(L_{SYS}(k), max(Lₓ(k))).

This is not essential and there are many possible variations, such as taking a weighted average emphasizing high loads or low priority components more than low loads or high priority components. In fact, in the simplest alternative, only the lowest priority component is taken into account.

The regulator 404 implements a regulation step, which can be implemented in various ways. In this embodiment, a target real-time performance metric in the form of a target system load L_{T}(k) is defined and system complexity is regulated to meet this target. In its most general form, a new overall target complexity metric C*(k) for system 300 as a whole is calculated in dependence on current and previous overall load indicators L(i), aggregate complexities C(i), and target loads L_{T}(i), with iε{0, 1, . . . , k}.

In this embodiment, regulator is realized as a PID (Proportional-Integration-Differential) controller. For a PID controller, the difference between this target and the actual system load, d(k)=L_{T}(k)−L(k), is calculated. The PID controller then calculates the new target system complexity by applying a correction factor to the current target system complexity:

$${C}^{*} ( k ) = C ( k ) + Pd ( k ) + I {\sum }_{i = 0}^{k} d ( i ) + D ( d ( k ) - d ( k - 1 ) ) \qquad ( 1 )$$

Here, P, I, and D are parameters of the PID controller. Techniques for setting them are known in the art and will be apparent to the skilled person; typically this will involve a degree of manual tuning.

Note that the PID controller correction step amounts to a linear combination of current and previous d(k), and as such it can be generalized to C*(k)=C(k)+Σᵢ₌₀^{k}a(i)d(k−i), with a sequence of parameters a(i). While this is no longer strictly a PID controller, it shares many properties with it and can be used instead.

In a simple implementation, the target system load L_{T}(k) is set it to a value corresponding to “just not overloaded” e.g. L_{T}(k)=0.95. However in this embodiment, to reduce oscillation, the calculation of d(k) includes some “hysteresis” so as to introduce a dead zone within which the current system load L(k) is tolerated and the components are not adapted. This is achieved by setting

$$d ( k ) = \{ \begin{matrix}{L}_{T}^{H} ( k ) - L ( k ) , & if L ( k ) > {L}_{T}^{H} ( k ) \\ {L}_{T}^{L} ( k ) - L ( k ) , & if L ( k ) < {L}_{T}^{L} ( k ) \\ 0 , & otherwise\end{matrix}$$

where L_{T}^{H}(k) and L_{T}^{L}(k) are high and low hysteresis thresholds respectively. Because L_{T}^{H}(k)−L(k) is necessarily negative in the above expression, exceeding the high hysteresis effectively modifies C*(k) in equation 1 above to reduce the overall complexity “available” to the various components X (which may, in turn, cause one or more components to reduce their individual complexities) when the overall load L(k) is sufficiently high. Likewise, because L_{T}^{L}(k)−L(k) is necessarily positive in the above expression, this effectively modifies C*(k) in equation 1 above to increase the overall complexity “available” to the various components X (which may, in turn, cause one or more components to increase their individual complexities) when the overall load L(k) is sufficiently low.

Whilst constants can be used for both, e.g. L_{T}^{H}(k)=0.95 and L_{T}^{L}(k)=0.75, in this embodiment at least L_{T}^{L}(k) is adapted by starting with a default high value of L_{T}^{L}(k), and then reducing it every time a system overload is observed, for instance by observing that one of L(k) exceeds 1, which occurs if one or more of L_{X}(k) exceeds 1 and/or, where L_{SYS}(k) is used, if L_{SYS}(k) exceeds 1. This way, the dead zone is broadened and lower loads are accepted every time regulation leads to overload

The final step is a distribution step performed by distributor 406, which can also be done in several ways. The simplest is to define priorities for the different components and split the total CPU availability according to that. For an arbitrary number of components, the complexity for a component X is calculated according to

$${C}_{X}^{*} ( k ) = \frac{{P}_{X}}{{Σ}_{n} {P}_{n}} {C}^{*} ( k ) ,$$

where Pₙ denotes the priority for component n. For example, audio component 304 may be assigned a priority of 7 and video component 314 a priority of 3 (so as to give some degree of “preferential treatment” to audio encoding), with C*(k) being split according to:

C_{A}*(k)=0.7*C*(k);

C_{V}*(k)=0.3*C*(k).

Additionally, the distributor can be made aware of the highest attainable complexity for each component. These limits can be taken into account together with the priorities using water filling techniques which are known in the art.

In more advanced embodiments, the application components supply to the distributor 406 mappings relating to a quality they can achieve given different complexity allocations and the distribution is done to maximize total application quality.

As indicated above, the actual numerical values of the C_{X}(k) metrics can be somewhat arbitrary. It is sufficient for each to satisfy a condition whereby, for each configuration of component X having a particular complexity, component X reports a unique value of C_{X}(k), although if the complexities C_{X}(k) are not reported in similar metrics (or “units”) having similar scales (such that similar values of C_{X1}(k) and C_{X2}(k) indicate that components X1 and X2 are implementing processing algorithms having a similar algorithmic complexity) then it may be necessary to normalize some or all of the C_{X}(k) metrics prior to aggregation such that the overall target complexity metric C_{X}*(k) can be apportioned in a meaningful way. Because each complexity metric C_{X}(k) is in the same metric as C_{X}*(k) and because C*(k) is adjusted whenever the load L(k) is too high or too low through PID control, the feedback loop ensured convergence towards the desired target load irrespective of the metric in which values of C_{X}(k) are reported.

One technique of normalizing is to invoke the components one by one ahead of time, thereby estimating a linear relationship A_{X} in L(k)≈A_{X}C_{X}(k). We can then normalize the complexities by those A_{X}.

It is not essential for the code components to supply complexity metrics C_{X}(k) at all: where C(k) values are not supplied, they may be replaced by the previous total complexity target C*(k−1), under the assumption that components do follow the suggested new complexities C_{X}*(k) immediately.

However, providing C_{X}(k) metrics as in the above embodiment typically results in greater stability (as is apparent using mathematical analysis) and typically results in faster convergence to the target system load (or to the dead zone)—for instance, in the case where the target C*(k), and thus the individual target C_{X}*(k), is reduced due to a change in operating conditions, component X (say) may be reconfigured to a complexity lower than C_{X}*(k) (if it is not possible for X to achieve a higher complexity without exceeding C_{X}*(k)). In this instance, C*(k+1) will be an overestimate of the aggregate system complexity and it will take some time for the feedback to correct for this.

A value of C_{X}(k) could pre-assigned to each configuration of component X by running each configuration of component X on a reference platform in isolation and measuring a number operations performed each second (measured in terms of e.g. MHz) for each configuration; using the same reference platform for each component would ensure each C_{X}(k) is in the same metric. Alternatively, C_{X}(k) could obtained at run-time by letting an external process monitor the complexity of each component, for example by monitoring CPU thread times.

In alternative embodiments, each code component X maintains a “local” iteration index k_{X} which is incremented each time component X processes a data portion. In this case each metric M_{X}(k) in the above is replaced with a corresponding metric M_{X}(k_{X}), in a manner that will be apparent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

For instance, in the above-described embodiments, both the first and second code components are real-time components. However, the second component, having configurable complexity, does not need to be a real-time component. As a specific example, we could monitor a real-time audio component and use that to configure complexity of a non-real-time component, for example, a component implementing decoding of a pre-downloaded advertisement clip.

Further, whilst embodiments have been described in which audio (resp. video) code components encode a sequence of audio (resp. video) frames, it will be readily appreciated that the underlying principles are applicable to any real-time code components which process a sequence of data portions. That is, the described embodiments are applicable to any two-or-more components—at least one of which operates in real-time and at least another of which has a configurable complexity (which may or may not be real-time)—which share finite processor resources during execution.

Complexity could be reconfigured for (e.g.) an echo canceller component by down-sampling audio in the same manner as the audio codec described above, or by switching to another, simpler echo canceller (either from memory or loaded from storage). For a (e.g.) noise reduction, complexity could be reconfigured by skipping noise reduction altogether, or by using a less complicated noise-reduction mechanism.

Further, in the above examples, each code component processes a distinct sequence of data portions (audio and video respectively). Alternatively, any two-or-more code components may process a same respective sequence of data portions. For instance, two-or-more audio processing code portions (resp. two-or-more video processing code portion), implementing independent processing algorithms on a same sequence of audio data (resp. video data), may be executed contemporaneously.

In alternative embodiments, a software application (such as client 206, or some other application(s)) may comprise any number of alternative or additional code components, each for processing a sequence of data portions, at least one of which is real-time and at least another of which has a configurable complexity. In order to preserve real-time operation of another (different) code component, the complexity of the code component may be reconfigured by modifying an algorithm implemented by the code component, so as to reduce an overall algorithmic complexity of the code component. For example, it may be the case that each data portion must be processed by the other component in no more than a target processing time to preserve real-time operation of the other code component. This is described in detail above with reference to audio and video data, but it will be appreciated that there numerous other situations in which this criteria must be satisfied to preserve real-time operation.

The data portions may have a temporal disposition in the sense that, once processed, a data portion must be output after a fixed interval relative to an immediately preceding data frame in the sequence; in this case, the target processing time must be no greater than said interval. Said interval may represent a (temporal) length of a data portion and/or a (temporal) separation of sequential data portions. Exemplary data portions include media data frames, such as audio and video frames (discussed above, where said target is set as an audio frame length or video frame separation), but are not limited to these.

The processed second data portions may have a quality which is acceptably degraded by reducing the complexity of the second code component whilst maintaining a current quality of the processed first data portions.

Moreover, alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Alternatively or additionally, any the functionality described herein may be implemented by executing code, stored on one or more computer readable storage devices, on a processor, or by a suitably configured user device.

For instance, complexity regulator 400 (including aggregator 402 and regulator 404) and distributor 406 could be implemented external to a processor executing code portions as hardware, firmware, software implemented on a separate processor or any combination thereof. Similarly, particularly in the case (discussed above) where individual complexity metrics C_{X}(k) are supplied by an external process (external to the processor executing the code components), this external process as hardware, firmware, software implemented on a separate processor or any combination thereof.

Finally, it should be noted that singular quantifiers (such as “a”, “and” etc.) do not preclude a plurality per se. This is particularly, but not exclusively, the case where used in the appended claims.

1. A method of allocating resources of a processor executing a first real-time code component for processing a first sequence of data portions and a second code component for processing a second sequence of data portions and having a configurable complexity, the method comprising:
estimating a first real-time performance metric for the first code component; and
configuring the complexity of the second code component based on the estimated first real-time performance metric.

2. A method according to claim 1, comprising monitoring real-time performance of the first code component, wherein the first real-time performance metric is estimated based on said monitoring.

3. A method according to claim 1, comprising determining from the first estimated real-time performance metric available processing resources of the processor, wherein the configuration step comprises reconfiguring the complexity of the second code component according to the determined available processing resources.

4. A method according to claim 1, wherein
the first data portions are frames of audio data and the first code component is a real-time audio code component for encoding audio frames and the second data portions are frames of video data and the second code component is a real-time video code component for encoding video frames; or
the first data portions are frames of video data and the first code component is a video code component for encoding video frames and the second data portions are frames of audio data and the second code component is an audio code component for encoding audio frames.

5. A method according to claim 1, wherein the first code component is one of a first set of real-time code components and the second code component is one of a second set of code components having configurable complexities, the first and second sets of code components being executed by the processor, the method comprising:
estimating real-time performance metrics for each of the first set of code components; and
configuring the complexity of each of the second set of code components based on the estimated real-time performance metrics for the first set;
wherein the first set and the second set are one of: identical, partially overlapping, or disjoint.

6. A method according to claim 1, wherein the first code component and the second code component each provide respective complexity metrics pertaining to their current complexities, and the step of configuring is based thereon.

7. A method according to claim 6, comprising aggregating the complexity metrics as an aggregate complexity metric, wherein the step of configuring is based on the aggregate complexity metric.

8. A method according to claim 7, wherein the step of aggregating comprises summing the complexity metrics.

9. A method according to claim 1, wherein the second code component is a real-time code component.

10. A method according to claim 9, comprising estimating a second real-time performance metric for the second code component, wherein the step of configuring is based on the first and second estimated real-time performance metrics.

11. A method according to claim 10, comprising estimating an overall real-time performance metric based on the first and second estimated real-time performance metrics, wherein the step of configuring is based on the overall real-time performance metric.

12. A method according to claim 11, wherein the overall real-time performance metric is further based on a system load reported by an operating system of the processor.

13. A method according to claim 11, wherein the step of estimating the overall real-time performance metric comprises selecting a maximum real-time performance metric as the overall real-time performance metric.

14. A method according to claim 1, comprising providing a target real-time performance metric, wherein the step of configuring is performed such that the target real-time performance metric is met.

15. A method according to claim 1, wherein the first real-time performance metric is a load indicator indicative of a time taken for the first code component to process a data portion relative to a target processing time.

16. A method according to claim 15, wherein each data portion has a temporal disposition, and said target time is based on an interval of the data portions.

17. A method according to claim 1, wherein the processed second data portions have a quality which is acceptably degraded by reducing the complexity of the second code component whilst maintaining a current quality of the processed first data portions.

18. A user device comprising:
a processor configured to execute a first real-time code component for processing a sequence of data portions, and a second code component for processing a second sequence of data portions and having a configurable complexity;
the user device further comprising:
an estimation component operable to estimate a real-time performance metric for the first code component; and
a configuration component operable to configure the complexity of the second code component based on the estimated real-time performance metric.

19. At least one computer-readable storage device storing code comprising a first real-time audio code component for processing a sequence of audio frames and a second real-time video code component for processing a sequence of video frames, each code component having a configurable complexity, said code being operable, when executed, to cause operations comprising:
estimating first and second real-time performance metrics for the first and second code components respectively;
estimating an overall real-time performance metric based on the estimated real-time performance metrics;
aggregating, as an aggregate complexity metric, first and second complexity metrics pertaining to current configurations of the first and second code components respectively;
calculating an overall target complexity metric based on the aggregate complexity metric and the overall real-time performance metric;
apportioning the overall target complexity metric as individual target complexity metrics for the first code component and the second code component respectively; and
configuring the complexities of the first code component and the second code component in dependence on the respective individual target complexity metrics.

20. At least one computer-readable storage device according to claim 19, wherein the overall target complexity metric C*(k) is calculated according to
$${C}^{*} ( k ) = C ( k ) + {\sum }_{i = 0}^{k} a ( i ) d ( k - i )$$
where C(k) is the overall complexity metric; d(k) relates to a difference between a target real-time performance metric and the overall real-time performance metric;
and k is indicative of time;
wherein the difference d(k) is calculated according to:
$$d ( k ) = \{ \begin{matrix}{L}_{T}^{H} ( k ) - L ( k ) , & if L ( k ) > {L}_{T}^{H} ( k ) \\ {L}_{T}^{L} ( k ) - L ( k ) , & if L ( k ) < {L}_{T}^{L} ( k ) \\ 0 , & otherwise\end{matrix}$$
where L(k) is the overall real-time performance metric, L_{T}^{H}(k) is an upper threshold value and L_{T}^{L}(k) is a lower threshold value.
